(19) United States
(12) Patent Application Publication
(10) Pub. No.: US 2008/0280524 A1
(43) Pub. Date: Nov. 13, 2008

(54) Combination mobile child's toy and identification device

(76) Inventor: Julius Joseph Kaufenberg, JR., Henderson, NV (US)

Correspondence Address: WEISS & MOY PC, 4204 NORTH BROWN AVENUE, SCOTTSDALE, AZ, 85251, US

(21) Appl. No.: 11/801,754

(22) Filed: May 11, 2007

(51) Int. Cl. A63H 33/00; B42D 15/00

(52) U.S. Cl. 446/227; 283/75

(57) ABSTRACT

A combination mobile child's toy and identification device is provided. A child's toy is coupled to a mobile child seat, which may be a car seat or stroller seat. Attached to the toy is an identification receptacle, which contains identification information. The identification receptacle is child-proof, so that it may not be opened by a child but may be opened by an adult, such as a first responder. The combination toy and device allows a child to “communicate” idnetifictio information to a first responder, when a caregiver has become suddenly injured or incapacitated.

### FIELD OF THE INVENTION

The present invention relates generally to mobile children's and, more particularly, to a mobile child's toy that also includes an identification device.

### BACKGROUND OF THE INVENTION

Child car seats often include a bar or the like across the lap of the seated child, to assist in securing the child in position, Similarly, strollers also typically include a bar or the like across the lap of the child, again for purposes of securing the child in position. In some instances, a single child seat may be utilizable either as a car seat or as part of a stroller. Toys may be secured to the bar or other securing device, to be accessible for play by a seated child.

The present invention involves the use of a mobile toy of a type that is secured to a car seat and/or stroller seat to both be a source of play for a seated child, while also providing a secure location therein for identification information concerning the child.

### SUMMARY OF THE INVENTION

In accordance with an embodiment of the present invention, a combination mobile child's toy and identification device is disclosed. The combination mobile child's toy and identification device comprises: a toy; means for securing the toy to a mobile child's seat; and a sealable identification receptacle coupled to the toy.

In accordance with another embodiment of the present invention, a combination mobile child's toy and identification device is disclosed. The combination mobile child's toy and identification device comprises: a toy; a mobile child's seat; means for securing the toy to the mobile child's seat; and a sealable identification receptacle coupled to the toy.

In accordance with a further embodiment of the present invention, a child identification method is disclosed. The method comprises: securing a toy to a mobile child's seat; providing a sealable identification receptacle coupled to the toy; securing identification information relating to a child seated in the mobile child's seat in the identification receptacle; and sealing the identification receptacle in a child-proof manner.

### BRIEF SUMMARY OF THE DRAWINGS

FIG. 1 is a front view of a combination mobile child's toy and identification device consistent with an embodiment of the present invention.

FIG. 2 is a rear view of the combination toy and identification device of FIG. 1 with the identification receptacle in the closed position.

FIG. 3 is a side view of the combination toy and identification device of FIG. 1.

FIG. 4 is a rear view of the combination toy and identification device of FIG. 1 with the identification receptacle in the open position.

### DETAILED DESCRIPTION OF THE PREFERRED EMBODIMENTS

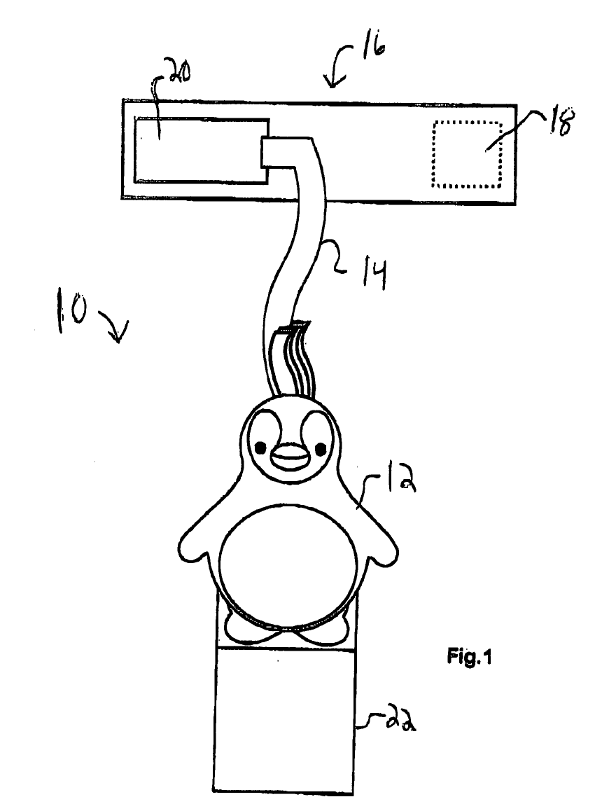

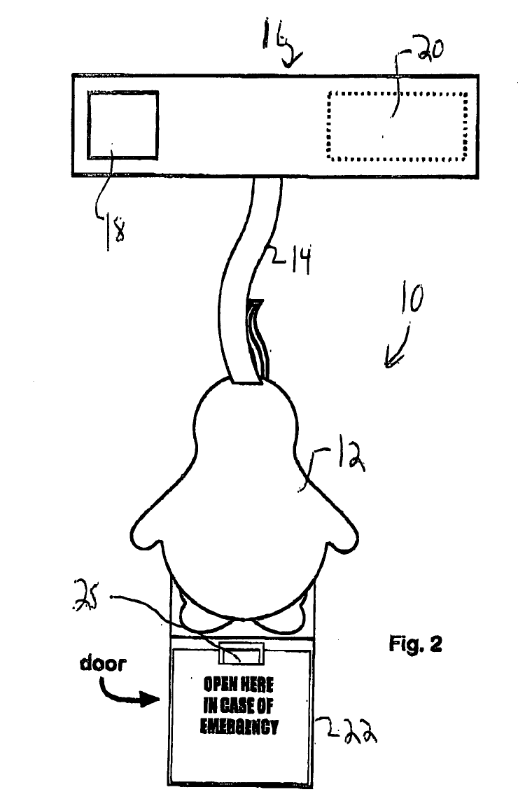

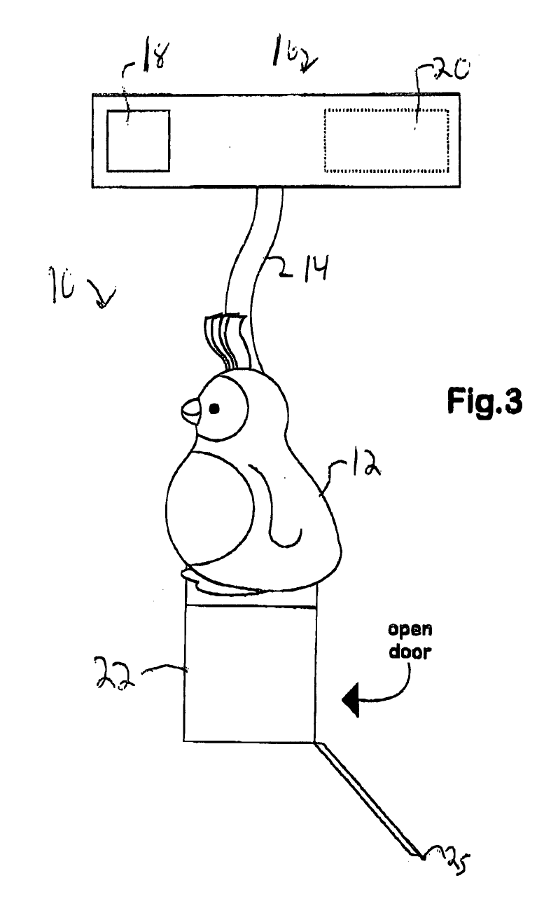

Referring to FIGS. 1-4, an embodiment of a combination mobile child's toy and identification device 10 is disclosed. In one embodiment, the device 10 comprises a toy 12, secured by elongated member 14 to an attachment strap 16. The attachment strap is adapted to be secured to a bar or other portion of a mobile car seat (not shown). The mobile car seat may be a car seat or a stroller seat.

In one embodiment, the attachment strap 16 utilizes hook and loop material to facilitate removable attachment to a mobile seat, such as a car seat or stroller. For example, a section of hook material 18 may be provided proximate one end of the strap 16, and a section of loop material 20 may be provided on an opposing surface and proximate a second end of the strap 16. A wrapping of the strap 16 over a bar or other like portion of a car seat permits the section of hook material 18 to be brought into contact with the section of loop material 20—securing the device 10 to the car seat.

It should be note that other attachment means may be provided, such as one or more snaps, one or more buttons, etc.

In one embodiment, a sealable identification receptacle 22 is coupled to the toy 12. The receptacle 22 is configured to receive therein identification material (not shown) concerning the occupant of the car seat. The identification material may include, for example, the child's name, address, the telephone number of the home in which the child lives, emergency contact information for a relative or friend, and/or any other information that may be beneficial to a first responder who discovers the child in the car seat in a situation in which a responsible adult is either not present or is incapable of providing necessary information concerning the child. The identification material may be printed or written on a card or the like and/or may be provided on a computer-readable medium.

Sealability of the receptacle 22 is intended to prevent the child from accessing the interior thereof and removing the identification material. Sealability may be provided by a lid 24 having a tab 26 that snaps into place over the receptacle 22, or that is otherwise engaged with the receptacle 22 in a manner that is child-proof; i.e., in a manner that a child of car seat/stroller age cannot open. The lid 26 may, in this embodiment, be opened by movement of the tab 25 away from a mating opening (not shown) in the receptacle 22. The lid 24 should be capable of being opened by an adult, without use of a key or other such object, so that a first responder could open the receptacle 22 in case of an emergency.

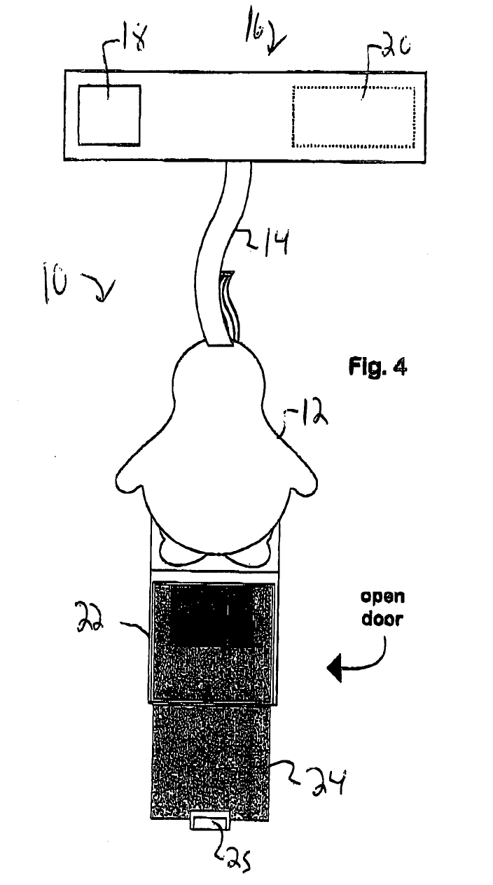

In one embodiment, the toy 12 is provided in a design that is common to a series of devices 10, so that the devices 10 will be recognizable to first responders as an identification-containing device—in the manner, for example, that a health-alert bracelet has a secondary meaning to first responders as a repository of safety information. For example, in this embodiment, the toy 12 is a penguin. In addition and/or in the alternative, it may be desired to provide a writing, as shown by way of example in FIG. 4, to alert a first responder that the receptacle 22 is to be opened so that the identification material contained therein may be found.

The device of the present invention may have utility where a caregiver who is with a child in a mobile car seat becomes injured or ill. In such a situation, a child who is unable to communicate cannot identify himself or herself to a first responder, to identify himself or herself, to provide a home address, to provide emergency contact information, or the like. By having such information in the receptacle 22, the child is able to “communicate” such information.

Although particular embodiments of the invention have been described in detail for purposes of illustration, various modifications may be made without departing from the spirit and scope of the invention. For example, for the purpose of enhanced information on the child, a computer web site identification will be included in the receptacle 22 which will provide a computer link to the child's medical data and any other relevant information, about the child, Accordingly, the invention is not to be limited, except as by the appended claims.

I claim:

1. A combination mobile child's toy and identification device comprising, in combination:
a toy;
means for securing the toy to a mobile child's seat; and
a sealable identification receptacle coupled to the toy.

2. The combination mobile child's toy and identification device of claim 1, wherein the mobile child's seat is a car seat.

3. The combination mobile child's toy and identification device of claim 1, wherein the mobile child's seat is a stroller.

4. The combination mobile child's toy and identification device of claim 1, further comprising an elongated member interposed between the toy and the securing means.

5. The combination mobile child's toy and identification device of claim 1 wherein the securing means comprises a strap having a section of hook material on a first side and proximate a first end thereof and a section of loop material on a second side and proximate a second end thereof, and wherein the securing means may be secured to a portion of a mobile child seat by positioning the strap over the portion and brining the section of hook material into contact with the section of loop material.

6. A combination mobile child's toy and identification device comprising, in combination:
a toy;
a mobile child's seat;
means for securing the toy to the mobile child's seat; and
a sealable identification receptacle coupled to the toy.

7. The combination mobile child's toy and identification device of claim 6, wherein the mobile child's seat is a car seat.

8. The combination mobile child's toy and identification device of claim 6, wherein the mobile child's seat is a stroller.

9. The combination mobile child's toy and identification device of claim 6, further comprising an elongated member interposed between the toy and the securing means.

10. The combination mobile child's toy and identification device of claim 6 wherein the securing means comprises a strap having a section of hook material on a first side and proximate a first end thereof and a section of loop material on a second side and proximate a second end thereof, and wherein the securing means may be secured to a portion of a mobile child seat by positioning the strap over the portion and brining the section of hook material into contact with the section of loop material.

11. A child identification method comprising:
securing a toy to a mobile child's seat;
providing a sealable identification receptacle coupled to the toy;
securing identification information relating to a child seated in the mobile child's seat in the identification receptacle; and
sealing the identification receptacle in a child-proof manner.

12. The method of claim 11 wherein the mobile child's seat is a car seat.

13. The method of claim 11 wherein the mobile child's seat is a stroller.

14. The method of claim 11, further comprising provided an elongated member interposed between the toy and the securing means.
